(19) United States
(12) Patent Application Publication
(10) Pub. No.: US 2019/0164530 A1
(43) Pub. Date: May 30, 2019

(54) Transduction of Electrical Signals into Magnetic Fields and Soundwaves

(71) Applicant: Michael J. Caselden, Brooklyn, NY (US)

(72) Inventor: Michael J. Caselden, Brooklyn, NY (US)

(21) Appl. No.: 15/825,072

(22) Filed: Nov. 28, 2017

(51) Int. Cl. G10H 3/18; G10H 1/32; G10H 1/04

(52) U.S. Cl. CPC G10H 3/186; G10H 2220/091; G10H 3/181; G10H 1/04; G10H 2220/165; G10H 2220/461; G10H 2220/201; G10H 2220/351; G10H 2210/115; G10H 2250/211; G10H 2220/376; G10H 2220/371; G10H 2220/455; G10H 2210/415; G10H 2210/481; G10H 2210/491; G10H 2210/401; G10H 1/32

(57) ABSTRACT

At least one electronic signal is converted into at least one electromagnetic field, where the electronic signal may be created or modulated by environmental, interactive, and programmed inputs. The at least one electromagnetic field vibrates a ferromagnetic element creating an acoustic sound and optionally a transducer converts the vibration into an electronic signal for processing.

### BACKGROUND

Music is an art form dating back to prehistoric times, originally comprising vocal and percussive elements to create intervals between sound and silence. The sounds also vary by duration, pitch, intensity, timbre, and other qualities.

People use music for religious, social, and cultural activities, as well as personal expression and experience. One can participate in the performance of music or be a listener, absorbing its emotion as an individual or a group.

After the voice, drums and then flutes likely were the first musical instruments. Stringed instruments followed, along with brass horns and so on, including modern electronic devices. The range of musical instruments is virtually unlimited as a musician may appropriate any device into an improvised instrument. Some instruments are better situated to a particular performer or audience. For example, one may prefer an acoustic sound versus digital, depending on the music, mood, and environment.

The distinction between creating and listening to music is important. One is a means of expression and the other a means of experiencing the expression of another. Both may be advantageous to the individual.

Of particular interest is the use of ambient or background music to create an atmosphere suitable for other activities, which might include socializing, focusing on a task, relaxation or even sleep. Popular forms of background music are primarily electronic compositions, but may include live performances as well. Chamber music, elevator music, movie scores, and advertisements are all examples of background music affecting the soundscape of a time or place. One may even include a white noise machine in an office setting as a form of background music, although the sounds are random in nature and not exactly a human composition.

One use of background music is for meditation and relaxation. Monks in various religious traditions have chanted to reach varied states of consciousness, and likewise may use instruments such as cymbals, bells, drums or a harmonium.

Recent interest in the use of music towards soundscaping and meditation has evolved into what is called a sound bath. These are meetings of groups of people, often in a meditation or yoga setting, where a performer plays a series of instruments over an extended period of time while participants relax and meditate. Typical instruments at sound baths include percussion and singing bowls.

Music and sound for meditation is useful for groups and individuals, but requires an experienced performer, a space to perform, and typically a large group to meet. It would be advantageous to provide this type of music without these constraints. A self-contained portable device that performs complex and varied sounds, acoustic and electronic, with or without an experienced operator, would be an ideal alternative.

### SUMMARY

The invention is an apparatus utilizing various natural and electronic inputs, providing acoustic and electronic audio output that creates sound by vibrating strings with an electromagnetic field. Some embodiments of the invention are entirely self-contained in a portable device, allowing one to use the invention in any habitable space.

It is preferable to sound baths in that an inexperienced individual can use the invention without any training, and may do so at any desired time and location. Additionally, the invention utilizes interactive queues as well as environmental and preprogrammed sequences to create unique and varied sounds. Each operation of the invention, a session, is entirely original with or without a user's interaction, creating a constantly changing and stimulating experience. Optionally, a user may record a previous session and play it back at a later time, with or without additional inputs, to create the same or a new variation of the previous session.

One embodiment of the invention is a hollow wooden box with a sound board, and holes in one side of the box. The box contains one or multiple metal strings across the sound board. If a string vibrates, the sound board amplifies the vibration and provides acoustic sound, like a violin or acoustic guitar. The box also may contain transducers, commonly called pickups, which sense the vibrating metal string with a magnet and convert it into an electronic signal. Each string may have one or more pickups. The electronic signal may be sent through an amplifier and out through a speaker, supplementing the acoustic sounds naturally generated by the sounding box.

Instead of human physical interaction with the string by strumming, plucking, or bowing, a magnetic field vibrates the string. One or more additional electromagnets are placed in close proximity to each string, and emit one or more magnetic fields. As a field reaches the string the ferromagnetic metal begins to vibrate according to the intensity and duration of the field, creating an acoustic sound.

Multiple inputs affect the quality of the magnetic field from each electromagnet. There are three basic types of input: environmental, interactive, and programmed.

Environmental input could be any environmental stimulus, sensed and converted into a digital signal for processing. One embodiment of the invention uses light sensors to record passing shadows. As the shadow turns the sensor on or off, the signal to transmit a magnetic field from an electromagnet may likewise turn on or off, creating an intermittent sound from the associated metal string. Other sensors may include temperature, pressure, and other remote sounds. Any type of sensor capable of translation into a digital signal may apply.

Interactive inputs are similar to environmental in that a sensor is coupled with an electromagnet. The difference is that a user will intentionally trigger the sensor to create the magnetic field and subsequent string vibration and sound. In fact, the environmental sensors may work simultaneously as interactive sensors. The main distinction is the user's intention. The user becomes a performer with interactive inputs rather than simply a listener. One embodiment of the invention uses a traditional user interface for the interactive inputs. A traditional user interface may be a touch screen, keyboard, mouse, button, slider or dial. Any user interface capable of recording an interaction and converting it into an electronic signal may apply.

Programmed inputs are part of the digital processing, and include modulation, compositions, and random variables. One embodiment of the invention modulates the digital signal or signals. The modulation may transform the signal into a specific waveform, vary the intensity of the signal, or vary the duration of the signal. There are multitudes of ways to modulate input signals.

In some embodiments, the programmed inputs also may provide a predefined composition. One may liken this to a written musical composition or a prerecorded digital composition. This is essentially a preprogrammed set of signals supplied to the electromagnets sequentially over a period of time.

In some embodiments, programmed inputs may also include random variables. An algorithm may apply random distributions when processing signals for transmission to the electromagnets. For example, the algorithm might provide a random variable from the Normal distribution for the duration of a signal to one of the strings, which is then applied to a predefined composition. The random variable will change the duration of some signals, creating a wholly new composition. When the seed value for the random distribution changes each time, the resulting session will be unique. Additionally, from a theoretical standpoint, the replay of a predefined composition will be unique regardless of the seed value, as the physical system and environment is inherently subject to natural variability.

Signal processing may utilize multiple random variables in the modulation of the input signals, regardless of whether the signals are coming from environmental, interactive, or predefined compositions.

The embodiments of the invention that utilize environmental inputs or random variables during signal processing are generative. The user may simply turn the invention on, and let the signals interact and create a rich and unique session every time.

### BRIEF DESCRIPTION OF DRAWINGS

FIG. 1 is a perspective view of one embodiment of the invention.

FIG. 2 is a diagram showing how inputs are converted into sounds.

FIG. 3 is a list of potential components in some embodiments of the invention.

FIG. 4 shows the generation of a digital signal for a single electromagnet.

FIG. 5 shows Microcontroller and MOSFET pin diagrams.

FIG. 6 lists potential inputs and variables affecting digital signals.

FIG. 7 shows a magnetic vector interaction with a string at a first moment in time.

FIG. 8 shows a magnetic vector interaction with a string at a second moment in time.

FIG. 9 is a system diagram showing one embodiment of the invention.

### DETAILED DESCRIPTION OF THE INVENTION

The invention is an apparatus utilizing various natural and electronic inputs, providing acoustic and electronic audio output that creates sound by vibrating strings with an electromagnetic field. Some embodiments of the invention are entirely self-contained in a portable device, allowing one to use the invention in any habitable space.

The basic components of the system are at least one electromagnet and at least one ferromagnetic vibrating element. A control signal in the form of an electric current produces a magnetic field through the electromagnet. The magnetic field interacts with the at least one ferromagnetic vibrating element, producing a vibration and sound.

Multiple separate components may form the system, or the system may exist entirely within a single device. Depending on the application, a distributed system or self-contained system may be preferred.

### Self-Contained Embodiment

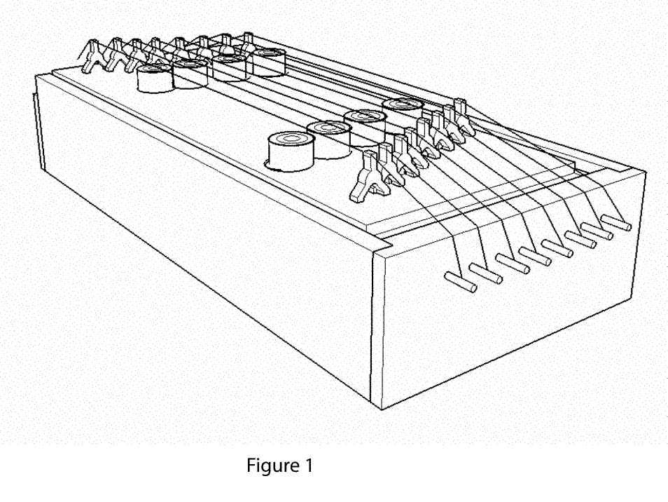

The best mode of the invention is a single device, as it affords portability. One embodiment of the invention is a wooden box with a sound board. At least one vibrating element is suspended across the sound board, but multiple vibrating elements provide a richer auditory experience. One embodiment of the invention has eight metal strings for vibrating elements. See FIG. 1.

Each string is oriented next to one or more electromagnets, which produce the magnetic fields for vibrating the strings. Each electromagnet is supplied with an electric current, providing independent magnetic fields for each string. The base current for each electromagnet is a control signal, which may be modulated through a variety of means, as discussed below.

The vibrating strings produce an acoustic sound on their own, which may be amplified by a sound board. Additionally, some embodiments of the invention include transducers, pickups, for detecting the vibrations of the strings. The transducers generate a second electric current that is sent to an audio output, a speaker system. Alternative embodiments of the invention include additional processing of the audio output prior to emission through a speaker system, or feedback of that audio signal back into the control system for the electromagnets.

### Vibrating a String

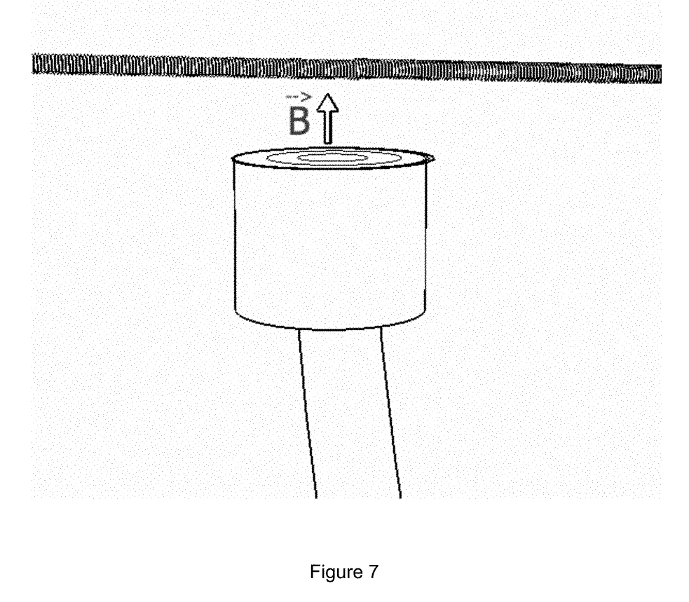

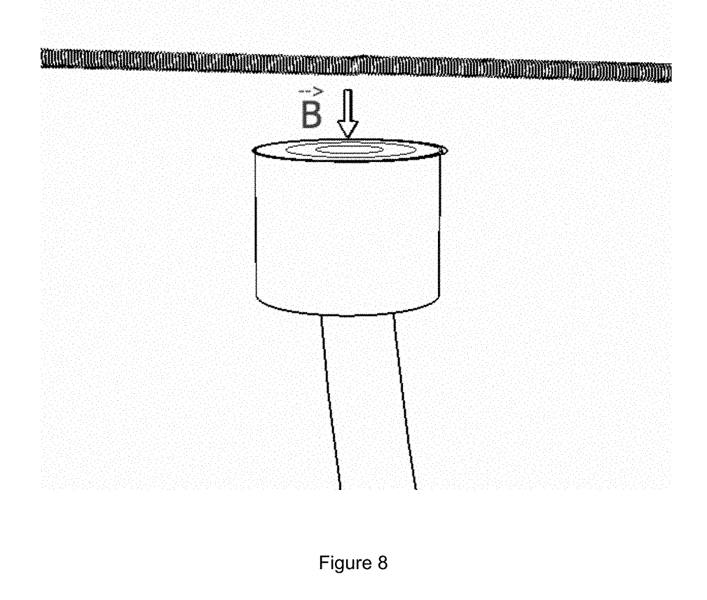

See FIGS. 7 and 8 for a demonstration of the mechanism for vibrating a string. FIG. 7 shows an electromagnet, a ferromagnetic metal string, and a magnetic vector B. The electromagnet generates the time-varying magnetic vector B, which applies a time-varying force to the string. As B varies, the force on the string induces standing waves into the string.

FIG. 7 shows the vector B exerting a force up into the string. In this example, the frequency of B is 500 Hz. This frequency has a period of 2 ms. FIG. 7 shows the vector at time equal to zero.

FIG. 8 shows the same configuration one millisecond later. Since the period is 2 ms, the forces exerted on the string from the electromagnet will alternate every millisecond. In FIG. 8, vector B exerts a force down, pulling the string. After another millisecond, the period is complete and the force will be back up towards the string, pushing it, as represented in FIG. 7. One millisecond later, the vector will pull the string again, alternating pushing and pulling every one millisecond.

In order to optimize the vibrations in a string, it is tuned to a specific pitch. In the example above, the string would be of a length and tension creating a resonant frequency of 500 Hz. The natural physical properties of the string will create a 500 Hz sound when vibrated manually as well as through a magnetic field. By tuning the string to a specific natural frequency, and generating a corresponding frequency from the electromagnet, a harmonious interaction between the field and the string maximizes the resulting oscillations.

Alternative embodiments of the invention may use a variety of components capable of creating an electromagnetic field, and solenoids or piezo transducers are envisioned. Additionally, focusing sound vibrations through a speaker cone in close proximity to a string may generate vibrations similar to an electromagnetic field.

Alternative embodiments may use a variety of vibrating elements as well. Instead of a ferromagnetic string, the vibrating element may be a plane, panel, gong, bell, singing bowl, rattle, beads, or any ferromagnetic percussive instrument.

### Low Frequency Modulation

The invention uses low-frequency modulation to create a margin of error for interacting with the string. Since the vibrating element is a physical object, it is exposed to nature and may expand or contract based on temperature or humidity. In order to ensure a robust interaction between the magnetic field and the string, the frequency oscillates around the fundamental frequency.

Consider a time-varying magnetic field with frequency 440 Hz. This will vibrate a string of matching resonant frequency 440 Hz, which is note “A” in a Western tuning system. If the “A” string is slightly out of tune due to cold air or another reason, the “A” string may better respond to 442 Hz. To account for natural phenomena in relation to the invention, low-frequency modulation may continuously adjust the frequency between 435 Hz and 445 Hz. This modulation will increase the likelihood of the field interacting with the string at its natural resonant frequency.

Low-frequency modulation has additional benefits as well. It creates rhythm and harmonics. As the frequency of the magnetic field cycles above, at and below the resonant frequency of the string, the volume of the vibration and audio output will swell up and down. This creates a rhythm dependent on the low-frequency modulation and the randomness of the natural resonant frequency of the string in its current physical environment. These rhythms may be audible, at a slow rate, or they may be so fast that the listener does not perceive them. Some resulting rhythms may be classified as isochronic tones adding another potential benefit in the field of brainwave entrainment.

Additionally, as the frequency of the magnetic field undulates, it can excite various harmonics within the string. If the magnetic field's frequency matches the fundamental frequency of the string, the string will resonate sympathetically at that fundamental frequency. If the magnetic field frequency instead matches a higher-frequency overtone of the string, the oscillations induced in the string will match that overtone. There is potential to hear entirely different tones from the same string, generated simultaneously or at different points in time. This process will increase the variety of timbre and reveal additional harmonic multiples of each string.

### Inputs

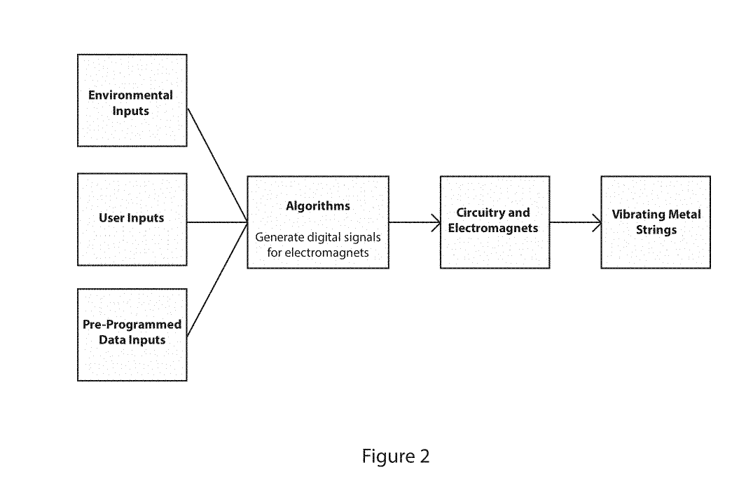

An electric signal supplies current to each electromagnet. The signal is created using one or more types of input, environmental, interactive, or programmed. See FIG. 2.

### Environmental Inputs

Environmental inputs utilize natural elements to create variable signals. One embodiment of the invention uses light as an environmental input. For example, a light sensor is connected to a control signal supplying current to one of the electromagnets. The light sensor detects a binary condition, whether light is reaching the sensor or not, and creates a switch for the input. When light is reaching the sensor, the switch is off. When no light is reaching the sensor, the switch is on. Using this sensor, a passing shadow will turn the control signal on, supplying current to the electromagnet and generating a sound through the associated string. After the shadow passes, the control signal will switch off, and the sound will stop.

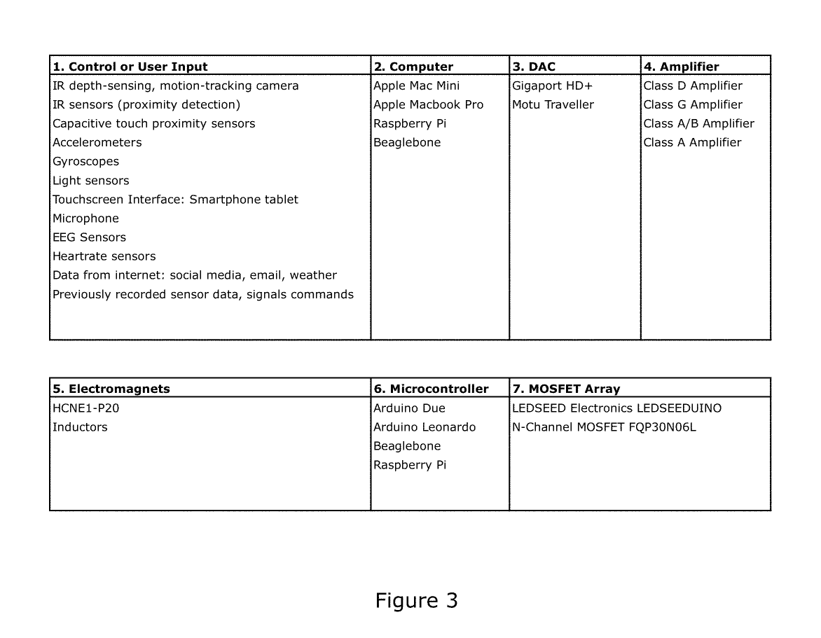

Additional environmental sensors may include infrared sensors, thermometers, accelerometers, motion sensors, gravity, humidity, vibration, pressure, chemical composition, sound, and scent. Any type of sensor capable of translating a natural cue into an electronic signal will provide environmental inputs modifying the control signal and the resulting auditory vibrations. Additional types of natural sensors may include biometrics from pulse detectors, electroencephalography, electrocardiography, magnetoencephalography, respiratory rate, skin conductivity, electromyography, and blood pressure. See FIG. 3 for a list of additional inputs.

### Interactive Inputs

Interactive user inputs may also affect the control signal. These inputs include standard user interfaces, such as computers with keyboards, mice, and other peripherals. One embodiment of the invention allows users to interact via a tablet touchscreen. Users may press buttons switching control signals on or off, as well as adjusting the associated intensity of the magnetic field and resulting volume of the audio output.

Interactive inputs may also include the environmental sensors described above. For example, a user may intentionally trigger a light sensor to switch a field on or off. Or as another example, a user may hold a thermometer, intentionally raising the temperature and altering the associated control signal. Alternate embodiments of the invention could track motion, location, gesture, voice, eye movement, and facial expressions.

### Programmed Inputs and Variables

In addition to environmental and interactive inputs, programmed inputs may alter the control signal. Some embodiments of the invention further comprise an electronic storage medium for storing programmed inputs. Programmed inputs include premade compositions and the incorporation of random variables.

The simplest control signal will be a single continuous waveform of fixed amperage and frequency. A programmed input may provide adjustments to the control signal, turning it on or off at certain intervals, and increasing or decreasing the amperage. These adjustments may be fixed, as in a composition, or they may be variable.

An important aspect of the invention is the ability to create generative performances. This means that each and every session has the potential to be new, providing a novel experience to the listener.

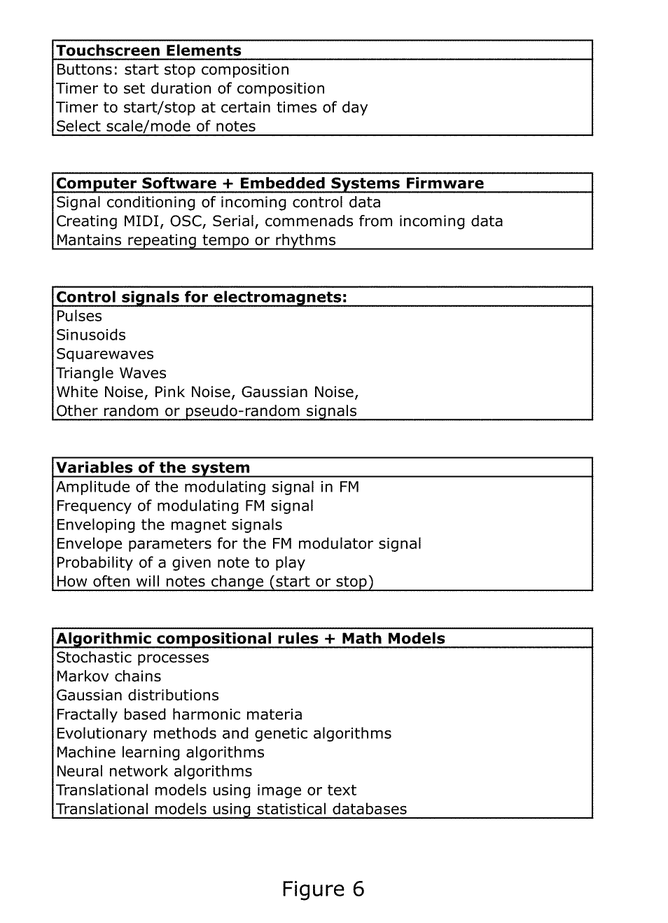

Environmental and interactive inputs may innately have an element of randomness, but the invention also affords the opportunity to program randomness into the control signal. FIG. 6 provides some example variables injecting randomness into the signal.

For example, amplitude of the control signal may be a variable adjusted according to a random distribution. The amplitude may increase or decrease around a mean according to the Normal distribution, creating alternating sound intensities from the associated string.

For another example, frequency may be adjusted according to the Poisson distribution. As the frequency modulation and the amplitude modulation interact, novel arrangements of sounds are generated from a single string.

Additional variables may be added, including the length of a note or the probability of sounding several notes in unison. Variables may be used as randomized parameters in control signal processing such as parametric equalization or frequency filtration, or additive synthesis of signals. More variables increase the complexity of the session, and further guarantee a novel listener experience.

Advanced additional random distributions in the form of mathematical models may further enhance the generative capabilities of the invention. See FIG. 6 for examples.

Another type of variable may take the form of a constraint. An example of a constraint could be an amplitude maximum or minimum, which would maintain sound intensity in a certain range. This amplitude constraint may be programmed to occur at random intervals, or it may be programmed to occur specifically at twenty minutes into a session, lowering the volume for a more relaxed experience.

Additional variables taking the form of constraints are related to the form of the waves themselves. Waves may be in a typical sine wave format, with smooth transitions through the period, or they may be in other shapes, such as triangle, square, or saw tooth. The format of the wave is included in a wave table, and the selection of waveform may be randomly selected by a variable, or intentionally programmed as a composition.

Waves may also be controlled through a sound envelope. The amplitude and frequency of a wave are given an upper and lower bound to stay within. The envelope may be fixed throughout, or a peculiar shape varying in upper and lower bound. Additionally, the envelope may change according to random variables.

### Cummulation of Signals and Modulations

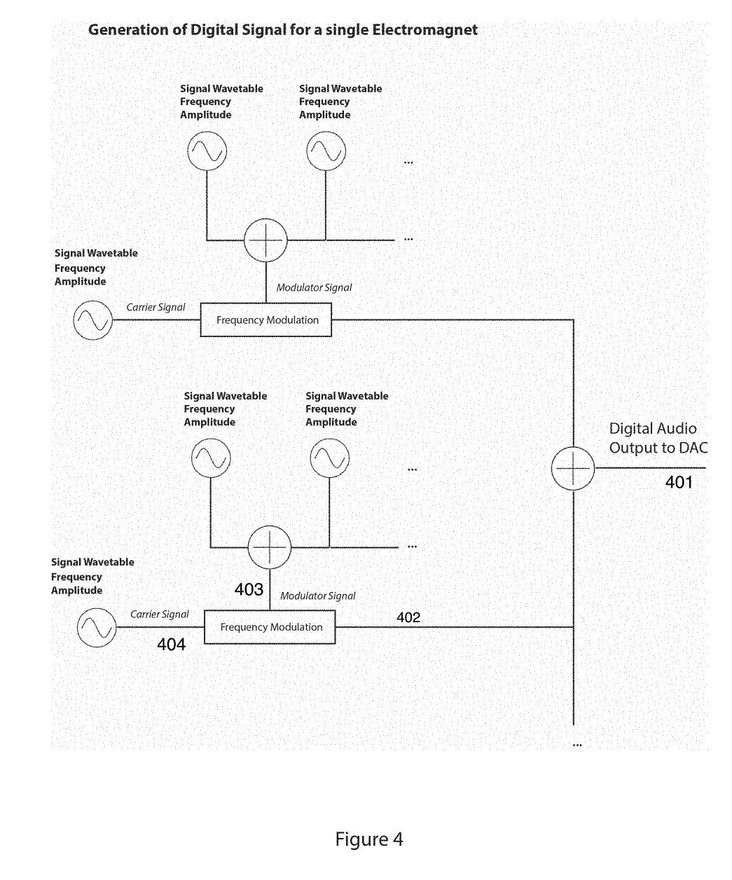

All of the inputs, modulations, programmed compositions and variables described above may be simultaneously applied to a single control signal for a single string. FIG. 4 shows an example of how each variable combines to form a single signal for an electromagnet.

A carrier signal 404 is a basic building block of the signal that ultimately reaches an electromagnet. The carrier signal is a simple repeating digital waveform. A modulator signal 403 may be used to alter the carrier signal. An example modulation includes the low frequency modulation discussed above. Additional modulations may combine to create more complicated modulator signals, including any number of the inputs and variables discussed above. After modulation, the resultant frequency-modulated signal 402 is passed up to a summing node, where other similarly modulated signals are combined to produce an output signal 401 sent to one of the electromagnets.

Alternative embodiments of the invention include analog implementations of the system. These include analog oscillators, envelopes, and summation circuits, comprised of op amps, transistors, and other electronics components suitable for large-scale production, as well as hybrid designs implementing both digital and analog elements.

Some embodiments may also include feedback from a pickup, a magnetic, piezo, or sound wave transducer detecting the output from the invention. This feedback will include additional natural/physical elements and enrich the control signals.

Some embodiments of the invention may utilize previously recorded sessions as carrier signals stored in an electronic storage device. For example, a user may record the output signal 401 so that a user can recreate the session, or create an iterative version of the session using it as part of the input to the system. Similarly, a user may record the output audio from transducers and use those signals as inputs to later sessions. Alternative embodiments of the invention may also include recorded audio data that exist independently of user input.

### IoT and Smart Device Implementation

Any analog or digital signal may be an input signal. It is envisioned that external data feeds from a variety of sources may provide input to the system. Examples include data feeds from remote devices connected through the Internet, also known as the “Internet of things” or IoT. An IoT device may provide a MIDI file or other data format as an input, and the invention itself might be considered an IoT device as a receiver and transmitter of information. IoT devices may communicate with the Internet through a variety of means, most commonly through wireless protocols, including WiFi, Bluetooth and Bluetooth Low Energy. This capability affords an extensive supply of data feeds as well as the ability to control input signals from a remote location. Exemplary data feeds could originate from social media services, email notifications, information from weather or news-related events, user-based forums, or cloud-computing and storage solutions.

Envisioned implementations of the invention allow control via smart devices such as smartphones, tablets, smartwatches, smart bands, phablets, and other consumer electronics or mobile devices.

### Tuning Systems

One embodiment of the invention utilizes eight strings tuned to a pentatonic scale. Alternative embodiments may include as little as one vibrating element, but the number of elements may increase depending on the application, and indefinite elements are envisioned.

The elements may be tuned under any system of scales or tones. Envisioned arrangements of elements include, just intonation, Pythagorean tuning, meantone temperament, well temperament, equal temperament, twelve tones of equal fifths, tempered timbres, slendro, pelog, Bohlen-Pierce, quarter-tone, thirteenth sound, schismatic temperament, miracle temperament, syntonic temperament, natural overtone scales, alpha, beta, delta and gamma scales.

When arranging the frequencies of the tuning systems it is important to also adjust the natural frequencies of the vibrating elements themselves. If one wishes to create a C major pentatonic scale, the elements should be tuned to C, D, E, G, A, C, D, E to correspond to the mean frequency of the associated magnetic field.

### Binaural Beats, Brainwave Entrainment, and Biofeedback

Some embodiments of the invention include acoustic output from the sound board as well as amplified output through a speaker system. Additionally, some alternative embodiments may include multiple speakers arranged on opposing sides of a listener. This arrangement affords the generative creation of binaural beats.

Binaural beats are created when the left and right ears of the listener hear two different frequencies. The brain interprets the difference, and generates a frequency at that difference. For example, if one ear hears a 124 Hz frequency and the other hears a 114 Hz frequency, the brain will generate a perceived pitch at 10 Hz frequency. The 10 Hz frequency is similar to alpha waves generated by the brain when relaxed or meditating.

The use of binaural beats is included in the field of brainwave entrainment, similar to isochronic tones, and may have the beneficial effect of creating desired conditions for enhanced meditation. Alternate embodiments of the invention could accommodate monaural beats, where two or more audio signals are projected from a single source, also slightly differing in frequency, generating a perceived low-frequency oscillation.

Sensor readings from real-time monitoring of neural oscillations can be used to influence the audio frequencies generated from the invention, creating a biofeedback system for brainwave entrainment. Other biological rhythms such as heart rate or breath rate could fulfill similar roles as input to the system.

### System Overview

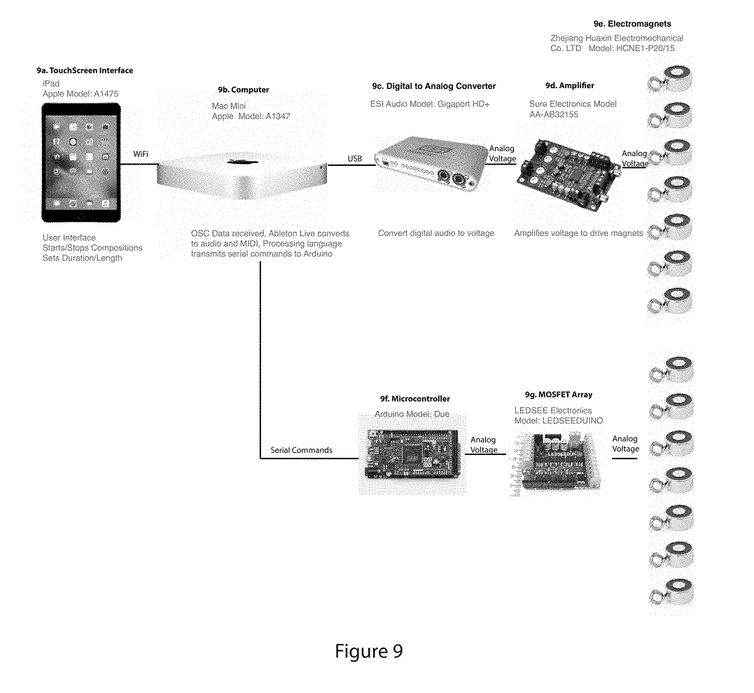

FIG. 9 shows the basic components of one embodiment of the invention. This embodiment includes a user input, a computer for processing the input and simultaneously sending it to a DAC and Microcontroller, an amplifier, electromagnets and a MOSFET array.

The user interface allows a user to control parameters supplying control signals to the system. The computer receives the user input and control signals, converting them to digital audio for the DAC, and serial commands for the Microcontroller. The DAC is a digital to analog converter, which converts the digital audio to analog and sends the analog voltage to an amplifier that forwards the voltage on to electromagnets. The Microcontroller receives the serial commands, and uses this data to control the MOSFETS. The MOSFETS control the electromagnets.

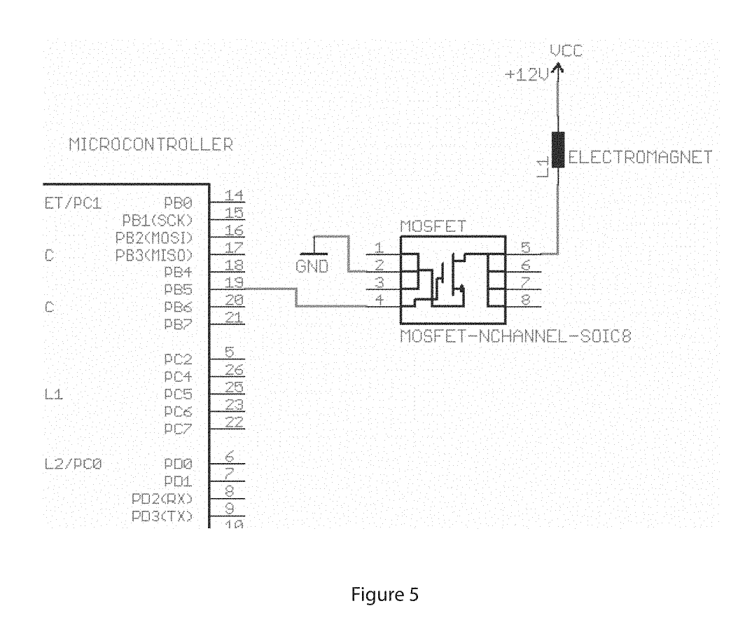

A MOSFET is a type of transistor used for amplifying and switching electronic signals. MOSFET stands for metal-oxide-semiconductor field-effect transistor. FIG. 5 shows one embodiment of the invention for a pin diagram of the MOSFET connecting to the microcontroller and an electromagnet.

The microcontroller cycles its pins on and off, from 5 V to 0 V, continuously. When a 5V signal passes from pin 19 to the receiving gate of the N-Channel MOSFET, the resistance between the source and drain pins of the MOSFET reduces to almost zero, allowing current to flow through the MOSFET. This creates a connection from the electromagnet to ground, allowing current to flow through the electromagnet.

Conversely, when a 0 V signal passes from pin 19 to the receiving gate of the N-Channel MOSFET, the resistance between the source and drain pins of the MOSFET increases to the extent that there is now only a negligible amount of current flow through the MOSFET. In this moment, the electromagnet is no longer connected to ground, so current flow transitions to essentially zero.

These cycles occur at audio frequencies, usually between the human audible range of 20 Hz and 20,000 Hz, generating magnetic vectors that oscillate in magnitude and direction at audio rates, capable of inducing standing waves in ferromagnetic elements at the same audible frequencies.

FIG. 3 lists alternatives for each component shown in FIG. 9.

### Alternative Embodiments

The best mode of the invention is a self-contained system in a wooden box. See FIG. 1. Alternative embodiments of the invention are envisioned, which embed the system in other objects or environments. The system may be in another object, such as sculpture or furniture. Other embodiments might incorporate the system into a building or outdoor space, placing the components in walls, ceilings or floors. The system may be placed in any space that a person may inhabit, or in vehicles such as trains, busses, cars, boats, planes, submarines, or hot air balloons.

Additional alternative embodiments may embed the invention into a pre-existing instrument, including a guitar, violin, cello, koto, sitar, harmonium, zither, harp, piano, ukelele, monochord, dulcimer, erhu, banjo, lute, viola, mandolin, or even a hurdy-gurdy.

The invention claimed is:

1. An apparatus for converting at least one primary electrical signal into at least one sound wave, the apparatus comprising:
a. at least one electromagnet;
b. at least one ferromagnetic element in proximity to the at least one electromagnet;
c. at least one primary electrical signal;
d. a means for generating random variations in the at least one primary electrical signal;
e. wherein the at least one primary electrical signal is modulated by the means for generating random variations, and input to the at least one electromagnet;
f. such that the at least one electromagnet generates at least one primary electromagnetic field, vibrates the at least one ferromagnetic element, and produces at least one sound wave.

2. The apparatus of claim 1, wherein the means for generating random variations in the primary electrical signal is a stochastic mathematical process.

3. The apparatus of claim 1, wherein the means for generating random variations in the primary electrical signal is a change in environmental condition.

4. The apparatus of claim 3, wherein the change in environmental condition is selected from the group consisting of:
a. visible light;
b. infrared light;
c. temperature;
d. humidity;
e. atmospheric pressure;
f. sound; and
g. scent.

5. The apparatus of claim 1, wherein the means for generating random variations in the primary electrical signal is an ongoing stream of structured digital data from one or more external sources.

6. The apparatus of claim 5, further comprising an interactive device, such that the interactive device provides the structured digital data.

7. The apparatus of claim 6, wherein the interactive device is selected from the group consisting of:
a. a smartphone;
b. a tablet;
c. a smart watch;
d. a smart band; and
e. a phablet.

8. The apparatus of claim 1, wherein the means for generating random variations in the primary electrical signal is a metric of human interaction.

9. The apparatus of claim 8, wherein the metric of human interaction is selected from the group consisting of:
a. motion;
b. location;
c. gesture;
d. voice;
e. eye movement; and
f. facial expression

10. The apparatus of claim 1, wherein the means for generating random variations in the primary electrical signal is biometric data.

11. The apparatus of claim 10, wherein the biometric data measurement is selected from the group consisting of:
a. electroencephalography;
b. electrocardiography;
c. magnetoencephalography;
d. respiratory rate;
e. skin conductivity;
f. electromyography; and
g. blood pressure.

12. The apparatus of claim 1, wherein the apparatus further comprises at least one pickup in proximity to the at least one vibrating ferromagnetic element,
a. such that the at least one pickup detects at least one secondary magnetic field generated by the at least one vibrating ferromagnetic element;
b. converts the at least one secondary electromagnetic field into at least one secondary electrical signal;
c. and the at least one secondary electrical signal modulates the at least one primary electrical signal.

13. The apparatus of claim 12, wherein the at least one secondary electrical signal modulates the at least one primary electrical signal concurrently.

14. The apparatus of claim 12, wherein the apparatus further comprises an electronic storage medium, such that the at least one secondary electrical signal is stored in the electronic storage medium for use to modulate the at least one primary electrical signal in a subsequent session.

15. The apparatus of claim 1, wherein the apparatus is comprised of at least two electromagnets in proximity to at least two ferromagnetic elements, such that the two ferromagnetic elements have two different resonant frequencies.

16. The apparatus of claim 15, such that the at least two ferromagnetic elements' resonant frequencies are related to each other according to a tuning system selected from the group consisting of:
a. just intonation;
b. Pythagorean tuning;
c. meantone temperament;
d. well temperament;
e. equal temperament;
f. tuning systems that construct the twelve-tone system as a cycle of twelve equal tempered fifths;
g. tempered timbres;
h. slendro, a pentatonic scale used in Indonesian music;
i. pelog, a scale used in Indonesian music;
j. Bohlen-Pierce scale;
k. quarter-tone scale;
l. thirteenth sound;
m. schismatic temperament;
n. miracle temperament;
o. syntonic temperament;
p. natural overtone scale, a scale derived from the harmonic series; and
q. alpha, beta, delta, and gamma scales.

17. The apparatus of claim 1, wherein the at least one vibrating ferromagnetic element is selected from the group consisting of:
a. string;
b. plane;
c. panel;
d. gong;
e. bell;
f. singing bowl;
g. rattle; and
h. bead.

18. An apparatus for converting at least one primary electrical signal into at least one sound wave, the apparatus comprising:
a. at least one electromagnet;
b. at least one ferromagnetic element in proximity to the at least one electromagnet;
c. an electronic storage medium;
d. at least one pre-programmed primary electrical signal stored in the electronic storage medium;
e. wherein the at least one pre-programmed primary electrical signal is input to the at least one electromagnet;
f. such that the at least one electromagnet generates at least one primary electromagnetic field, vibrates the at least one ferromagnetic element, and produces a sound wave.

19. The apparatus of claim 18, wherein the apparatus is comprised of:
a. at least two electromagnets;
b. at least two pre-programmed primary electrical signals; and
c. at least two ferromagnetic elements,
d. such that the at least two ferromagnetic elements have at least two different resonant frequencies;
e. wherein the at least two pre-programmed primary electrical signals are input to the at least two electromagnets;
f. such that the at least two electromagnets generate at least two primary electromagnetic fields, vibrating the at least two ferromagnetic elements, and producing at least two sound waves.

20. The apparatus of claim 19, such that the at least two ferromagnetic elements' resonant frequencies are related to each other according to a tuning system selected from the group consisting of:
a. just intonation;
b. Pythagorean tuning;
c. meantone temperament;
d. well temperament;
e. equal temperament;
f. tuning systems that construct the twelve-tone system as a cycle of twelve equal tempered fifths;
g. tempered timbres;
h. slendro, a pentatonic scale used in Indonesian music;
i. pelog, a scale used in Indonesian music;
j. Bohlen-Pierce scale;
k. quarter-tone scale;
l. thirteenth sound;
m. schismatic temperament;
n. miracle temperament;
o. syntonic temperament;
p. natural overtone scale, a scale derived from the harmonic series; and
q. alpha, beta, delta, and gamma scales.

21. The apparatus of claim 18, wherein the apparatus further comprises at least one pickup in proximity to the at least one vibrating ferromagnetic element,
a. such that the at least one pickup detects at least one secondary electromagnetic field generated by the at least one vibrating ferromagnetic element;
b. converts the at least one secondary electromagnetic field into at least one secondary electrical signal;
c. and the at least one secondary electrical signal modulates the at least one pre-programmed primary electrical signal.

22. The apparatus of claim 21, wherein the at least one secondary electrical signal modulates the at least one pre-programmed primary electrical signal concurrently.

23. The apparatus of claim 21, such that the at least one secondary electrical signal is stored in the electronic storage medium for use to modulate the at least one pre-programmed primary electrical signal in a subsequent session.

24. The apparatus of claim 18, wherein the at least one vibrating ferromagnetic element is selected from the group consisting of:
a. string;
b. plane;
c. panel;
d. gong;
e. bell;
f. singing bowl;
g. rattle; and
h. bead.

25. The apparatus of claim 18, further comprising an interactive device, such that the interactive device provides structured digital data.

26. The apparatus of claim 25, wherein the interactive device is selected from the group consisting of:
a. a smartphone;
b. a tablet;
c. a smart watch;
d. a smart band; and
e. a phablet.
